(19) United States
(12) Patent Application Publication
(10) Pub. No.: US 2005/0274434 A1
(43) Pub. Date: Dec. 15, 2005

(54) Log positioning apparatus and associated method

(75) Inventor: Van Woodham, Daphne, AL (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: PSI Sales, Inc.

(21) Appl. No.: 10/856,276

(22) Filed: May 28, 2004

(51) Int. Cl. B27C 1/12; B27C 5/02; B27B 31/00; B27B 1/00; B23Q 15/00; B23Q 16/00; B27H 1/00; B27M 1/00; B27M 1/08; B27C 9/00

(52) U.S. Cl. 144/359; 144/242.1; 144/250.25

(57) ABSTRACT

A appartus, system, and method are provided for positioning a log for cutting. The apparatus includes a plurality of log-transferring members having a common rotational axis and each having a plurality of log positioner arms extending generally about the rotational axis. The log positioner arms include a lifting surface and a supporting surface circumferentially spaced from the lifting surface such that the lifting and supporting surfaces define a cradle therebetween. The apparatus also includes a drive shaft operable to rotate the plurality of log-transferring members such that a log is retained within the cradle during rotation of the log from a first position adjacent to the lifting surface to a stationary position adjacent to the supporting surface. The log is operable to be cut while supported in the stationary position.

### BACKGROUND OF THE INVENTION

1) Field of the Invention

The present invention relates to the positioning of logs and, more particularly, to an apparatus and associated method for positioning a log for cutting prior to transferring the log to a sawmill.

2) Description of Related Art

A variety of systems are used in the logging industry to position logs for processing. For example, U.S. Pat. No. 4,040,459 to Bush, Jr. et al. discloses a log handling system for use in processing logs to be used in sawmill operations. The log handling system includes a plurality of radially projecting arms having a log cavity portion for receiving and supporting a log therein. The projecting arms are engaged by a common support shaft and driven into rotation by a rotary drive. As logs travel down the downward ramp means by gravity, the projecting arms pick up the logs in the log cavity portions and advance them towards the cutting assemblies to cut the log into predetermined lengths. Each cutting assembly includes a pair of rotary cutting discs, and as the projecting arms rotate, the log is lifted upwards into contact with the cutting discs. The cut portions of the log are then deposited into a collecting trough to be conveyed for further processing.

U.S. Pat. No. 6,539,993 to Starr discloses a method and apparatus for singulating, debarking, scanning, and automatically sawing and sorting logs into lengths. The log handling system cuts logs into lengths to reduce the amount of wasted wood fiber. The logs are singulated using a dual quadrant singulation system, which includes two log handling lines. The volume and diameter of the logs are scanned prior to removing the bark to minimize the amount of wasted white wood. The length of the logs are then scanned again to determine the preferred lengths to be cut. In addition, the logs are dropped into a respective cradle by a bucking line-stop loader, and based on the computer scan, positioned by a respective bucking line positioner. The bucking line positioners contact the butt ends of the respective logs and move the logs to a predetermined location for cutting by two pairs of saws, although long logs can require three or more saws. In addition, the cutting saws are mounted on rollers and tracks so that the distances between the saws on each respective log handling line may be varied. After the saws cut the logs, the cradle is then rotated to allow the cut logs to drop from the cradle onto a conveyor.

U.S. Pat. No. 6,543,498 to Woodham discloses a log cutting system, which is assigned to the assignee hereof and is incorporated herein by reference. The log cutting system includes multiple cutting blades that can be positioned to cut a log laterally or perpendicular to the centerline of the log. A log positioner is used to position the log prior to being cut based upon a log contour developed by a system of multiple laser beams. In addition, the computer system actuates an appropriate number of saw blades so that the log can be properly cut. Each of the cutting blades is rotatably mounted on a respective arm, which in turn, is pivotally mounted on a shaft, the cutting blades being mounted in groups of four such that each drive operates four blades. Hydraulic lifters are used to partially rotate the saw blades into a cutting position.

While these devices may be suitable for the purposes for which they were designed, they would not be as suitable for the purposes of the present invention, as hereinafter described.

### BRIEF SUMMARY OF THE INVENTION

The present invention provides a log positioning assembly, system, and method for positioning logs for cutting. The log positioner advantageously includes a plurality of log-transferring members that operate to both convey and support the logs during cutting. In addition, adjustable log positioners and cutting blades are provided that position the log to reduce the amount of log waste. Thus, the improved log positioner is able to efficiently convey logs for cutting and accurately cut the logs in predetermined positions.

In one embodiment of the present invention, an apparatus for positioning a log for cutting is provided. The apparatus includes a plurality of log-transferring members having a common rotational axis and each having a plurality of log positioner arms extending generally about the rotational axis. The log positioner arms include a lifting surface and a supporting surface circumferentially spaced from the lifting surface such that the lifting and supporting surfaces define a cradle therebetween. The apparatus also includes a drive shaft operable to rotate the plurality of log-transferring members such that a log is retained within the cradle during rotation of the log from a first position adjacent to the lifting surface to a stationary position adjacent to the supporting surface. The log can be cut while supported in the stationary position.

Each of the log-transferring members can include four log positioner arms arranged about the rotational axis such that each of the four log positioner arms is operable to lift a log and collectively the four arms lift a plurality of logs sequentially on the lifting surfaces and support the logs on the supporting surfaces as the drive shaft is rotated. The log-transferring members can be arranged in sets of at least two, with each set of log-transferring members being coaxially arranged such that each set of log-transferring members is operable to simultaneously lift the log to be cut. In addition, each of the log-transferring members is operable to rotate at least 360 degrees. Each of the log positioner arms is preferably cylindrical such that the log is operable to slide longitudinally while supported in the stationary position.

The cradle typically includes an intermediate surface extending between the lifting and supporting surfaces of each of the log positioner arms. When the log is rotated from the first position to the stationary position, the log is substantially in contact with the intermediate surface. The lifting surface of each of the log positioner arms is defined such that the lifting surface engages the log, and as the drive shaft is rotated, the log is advanced along the intermediate surface to the supporting surface. The log is supported in the stationary position within the cradle adjacent to the supporting surface and intermediate surface during cutting, and further rotation of the drive shaft discharges the log from the log positioner arm.

In a variation of the present invention, a log positioning assembly for positioning a log for cutting includes a plurality of 360-degree rotatable log-transferring members having a common rotational axis and each having a plurality of log positioner arms extending generally about the rotational axis. Each of the log positioner arms includes a lifting surface and a supporting surface circumferentially spaced from the lifting surface to define a cradle therebetween. The log-positioning assembly also includes a log positioner operable to longitudinally move a log to a predetermined position while the log is supported on the supporting surface.

The log positioner is operable to move each log while the log is supported on a respective supporting surface on each of the log positioner arms. The log positioning assembly can also include a plurality of rollers located in a pick-up station upstream of each of the log-transferring members. The rollers rotate such that a log is advanced to a predetermined longitudinal position. The assembly could also include a scanner operable to scan a log contour and generate a preferred cutting solution so that the log positioner moves the log to a predetermined longitudinal position based on the log contour. Furthermore, the assembly can include a plurality of cutting blades that are operable to cut the log while the log is supported on the supporting surface of each of the log positioner arms. At least one of the plurality of cutting blades are advantageously operable to slide relative to the log-transferring members longitudinally to a predetermined position based on the log contour.

The present invention also provides a method of positioning a log for cutting. The method includes providing a plurality of log-transferring members having a common rotational axis and each having a plurality of log positioner arms extending generally about the rotational axis. The log positioner arms include a lifting surface and a supporting surface that define a cradle therebetween. The method also includes rotating the plurality of log-transferring members about a drive shaft such that a log is lifted and retained within the cradle during rotation from a first position adjacent to the lifting surface to a second position adjacent to the supporting surface. In addition, the method includes stopping the rotation of the log-transferring members at a predetermined position, and then cutting the log in at least one location with at least one of a plurality of cutting blades while the log is supported on the supporting surface.

In variations of the method, the method also includes directing the log longitudinally to a predetermined position with a plurality of rollers prior to rotating the plurality of log-transferring members about the drive shaft. The method can also include moving the log longitudinally, in a direction opposite to the direction of the directing step, to a predetermined position prior to cutting the log. The method could include scanning the log to generate a log profile, and moving the log to a predetermined longitudinal position based on the log profile. Additionally, the method can include sliding at least one of the plurality of cutting blades longitudinally to a predetermined position based on the log profile prior to cutting the log, and subsequently discharging the log from the log positioner arms following the cutting step by further rotating the log-transferring members.

In another embodiment of the present invention, a system for positioning logs for cutting is provided. The system includes a pick-up station into which a log is deposited for transfer to a cutting station, and a first log positioner operable to longitudinally move a log to a predetermined position while located in the pick-up station. A single-stage feeder is operable to lift the log from the pick-up station and advance the log from the pick-up station to the cutting station where the log is cut by at least one saw. The single-stage feeder includes a plurality of rotary log-transferring members mounted on and longitudinally spaced apart along a rotatary drive shaft, with each log-transferring member defining a log-lifting surface and a log-supporting cradle circumferentially spaced from the log-lifting surface in the rotational direction of the log-transferring member. The log-transferring members are structured and arranged such that a log in the pick-up station is engaged by the lifting surfaces of the log-transferring members as the log-transferring members are rotated into a pick-up position by the drive shaft. The drive shaft then further rotates the log-transferring members into a cutting position so as to lift and move the log from the pick-up station into the log-supporting cradles of the log-transferring members. The system also includes at least one saw positioned adjacent the single-stage feeder and structured and arranged to be advanced to saw through a log held in the cutting position in the log-supporting cradles, as well as a second log positioner operable to longitudinally move a log in the cutting station to a predetermined position.

The system can optionally include a driven saw positioning system operable to adjust the longitudinal positioning of each saw with respect to the log-transferring members. The driven saw positioning system comprises a scanner operable to scan a log contour and generate a preferred cutting solution. The second log positioner is operable to move the log to a predetermined longitudinal position based on the log contour.

The present invention includes yet another system for positioning logs. The system includes a first log positioner operable to longitudinally move a log to a predetermined position while the log is in a pick-up station. The log is deposited into the pick-up station for transfer to a cutting station. A single-stage feeder is operable to lift the log from the pick-up station and advance the log from the pick-up station to the cutting station where the log is cut by at least one saw. The single-stage feeder includes a plurality of 360-degree rotary log-transferring members longitudinally spaced apart along a rotatary drive shaft, with each log-transferring member defining a log-lifting surface and a log-supporting cradle circumferentially spaced from the log-lifting surface in the rotational direction of the log-transferring member. The log-transferring members are structured and arranged such that a log in the pick-up station is engaged by the lifting surfaces of the log-transferring members as the log-transferring members are rotated into a pick-up position by the drive shaft. The drive shaft further rotates the log-transferring members into a cutting position so as to lift and move the log from the pick-up station into the log-supporting cradles of the log-transferring members. At least one saw is positioned adjacent the single-stage feeder and is structured and arranged to be advanced to saw through a log held in the cutting position in the log-supporting cradles.

The present invention provides an additional apparatus for positioning logs for cutting. The apparatus includes at least one saw positioned adjacent to a single-stage feeder. The single-stage feeder includes a plurality of log-transferring members, and the saw is structured and arranged to be advanced to saw through a log held by the plurality of log-transferring members. The apparatus also includes a log positioner operable to longitudinally move a log held by each of the log-transferring members to a predetermined position, and a driven saw positioning system operable to adjust the longitudinal positioning of each saw with respect to the single stage feeder.

The driven saw positioning system can include a scanner operable to scan a log contour and generate a preferred cutting solution, while the second log positioner can move the log to a predetermined longitudinal position based on the log contour. In additional variations of the apparatus, each log-transferring member can define a lifting surface and a supporting surface circumferentially spaced from the lifting surface. In this configuration, the lifting and supporting surfaces define a cradle therebetween. Further, the apparatus can include at least one saw positioned adjacent to each of the log-transferring members and can be structured and arranged to be advanced to saw through a log held on a respective supporting surface within the log-supporting cradle.

The log-positioning system of the present invention provides a fully automated system for separating, conveying, and cutting logs. The combination of the scanners, log positioners, log-transferring members, and cutting blades provide an accurate system for minimizing log waste by positioning the log so that potential imperfections in the log are removed. Each of the log-transferring members provides a surface that enables the log to slide when moved by a log positioner, and also conveys the log from the pick-up station and supports the log while being cut by the cutting blades. Thus, the log-transferring members can perform many different functions, which reduces the time required to position the log for cutting, and also eliminates additional moving parts that would typically be required to perform multiple log-positioning procedures. Additionally, positioning the log while the log is supported on the log-transferring members provides improved accuracy in positioning the logs, as the cutting blades will immediately cut the logs when engaged with the log such that there is a lesser chance of the logs being misaligned when the logs are further transferred to a cutting station.

### BRIEF DESCRIPTION OF THE SEVERAL VIEWS OF THE DRAWNG(S)

Having thus described the invention in general terms, reference will now be made to the accompanying drawings, which are not necessarily drawn to scale, and wherein:

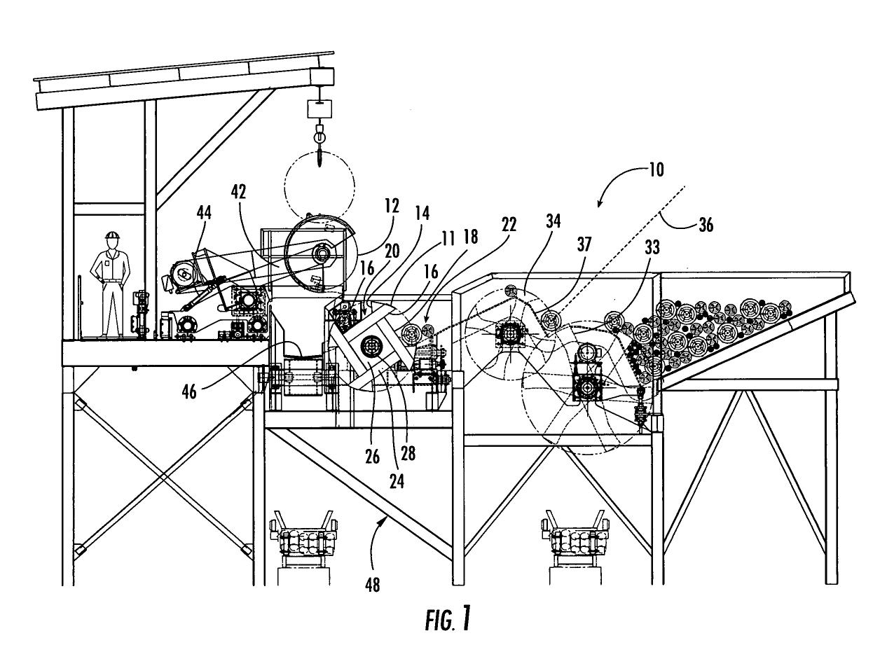

FIG. 1 is an elevation view of a log-positioning system according to one embodiment of the present invention;

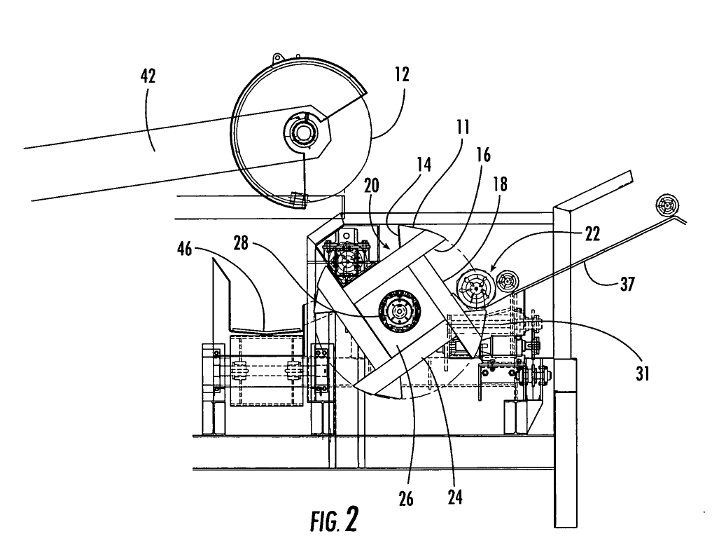

FIG. 2 is a detail elevation view of a log-transferring member according to one embodiment of the present invention;

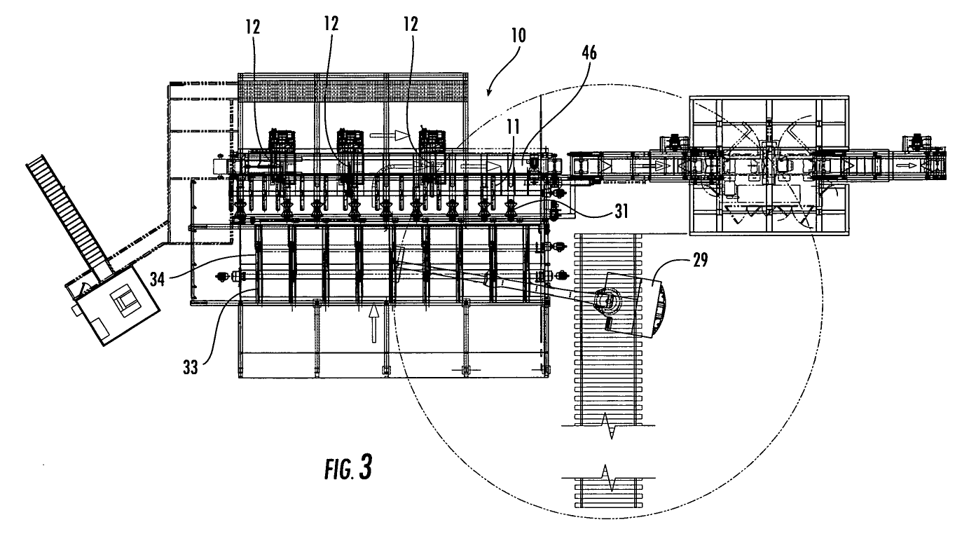

FIG. 3 is a plan view of the log-positioning system shown in FIG. 1; and

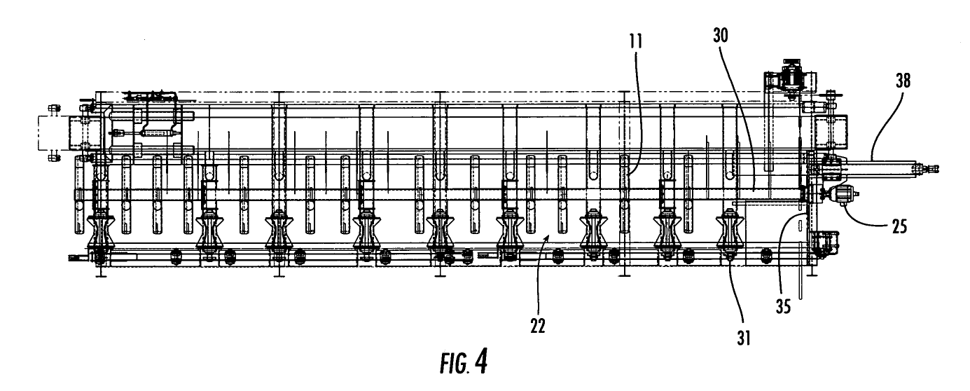

FIG. 4 is detail plan view of a log pusher shown in FIG. 1.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

FIG. 1 depicts a log-positioning system 10 including log-transferring members 11 that rotate to advance a log to be cut by any number of cutting blades 12. The log is positioned using a combination of log positioners and scanning techniques to best utilize the logs for processing, as will be explained further below. In addition, each of the cutting blades 12 can slide longitudinally (i.e., parallel to the centerline of the log) to a predetermined position to cut the logs in any desired location.

In particular, FIG. 2 illustrates that the log-transferring members 11 include a lifting surface 14 and a supporting surface 16. An intermediate surface 18 extends between the lifting 14 and supporting 16 surfaces to define a cradle 20 therebetween. At the point where the log is first lifted from the pick-up station 22, the log rests on the lifting surface 14 and a portion of the intermediate surface 18. Further rotation of the log-transferring members 11 causes the log to travel downwardly by gravity along the intermediate surface 18 until the log engages the supporting surface 16. Once the log reaches this position, the cutting blades 12 can be lowered to cut the log while the log is supported on the supporting surface 16 and a portion of the intermediate surface 18.

There are four log positioner arms 24 arranged circumferentially about the center of the log-transferring members 11 to substantially form a square. A shaft-engaging 26 member extends between each of the log positioner arms 24 and defines a hole 28 that may be engaged by a rotary drive shaft 28. The log-positioner arms 24 attach to one another so that one end of each arm abuts another log-positioner arm at one end, and the other end of each arm extends past the abutting end of an adjacent log-positioner arm. Thus, the end of the log positioner arm 24 that extends past the adjacent log-positioner arm defines one supporting surface 16. Each lifting surface 14 is generally triangular and extends outwardly from the surface of a respective log positioner arm 24 such that as the log-transferring members are rotated, the lifting surface engages a log and lifts the log upwards and into the cradle 20. Furthermore, in this configuration the log-transferring members 11 can lift and support individual logs in a sequential manner as each log is advanced by a respective log-positioner arm 24. Generally, only one log will be lifted and supported for cutting by the log-transferring members 11 at any given time.

The log-positioner arms 24 are preferably cylindrical so that they define a rounded edge that the log contacts during lifting and supporting of the log. The rounded edges promote rolling when the log is advanced from the lifting surface 14 to the supporting surface 16. Furthermore, as will be explained further below, a log pusher 38 is used to move the log to a predetermined position while the log is supported on the supporting surface 16. Incorporating rounded edges on both the supporting 16 and intermediate 18 surfaces promotes sliding when the log pusher moves the log longitudinally while the log is supported.

The log-transferring members 11 can be manufactured in any number of ways. For example, each of the log-positioner arms 24 may be welded to one another and to the shaft-engaging member 26, or cast as a single piece. The shaft-engaging member 26 is attached or integrally formed with the log-positioner arms 24 to enable the rotary drive shaft 30 to transfer rotation from a motor 25 to the log-positioner arms. In addition, the lifting surface 14 may be separately attached to a respective log-positioner arm 24, or integrally formed with the log-positioner arm. The log-transferring members 11 are typically manufactured from a suitable metal such as steel, although any suitable material may be used that is able to withstand rotation and positioning of the logs.

As shown in FIGS. 1, 3, there are several log-transferring members 11 spaced longitudinally along a rotary drive shaft 28. The rotary drive shaft 30 engages the shaft-engaging member 26 through hole 28 of each log-transferring member 11 such that the rotary drive shaft can rotate the log-transferring members concurrently when driven by a motor 25. As the rotary drive shaft 30 is rotated, the log-transferring members 11 act in unison to engage the log in the pick-up station 22 with the lifting surface 14, and as the log-transferring members are rotated by the drive shaft 28 with the motor 25, the log is advanced to the supporting surface 16. The log-transferring members 11 can be stopped while the log is held on the supporting surface 16 and a portion of the intermediate surface 18 so that the log pusher 26 can move the log to a desired location, and the cutting blades can then be lowered to cut the log while the log is being supported. Further rotation of the log-transferring members 11 causes the cut pieces of the log to be discharged from the cradle 20. Thus, the log-transferring members 11 at least rotate from the pick-up station 22 to a position to be cut by the cutting blades 12, but generally rotate at least 360 degrees. As such, the log-transferring members 11 can rotate to transfer logs sequentially from the pick-up station 22.

It is possible to have any number of log-transferring members 11, and typically at least two, to provide sufficient lifting and supporting of the log while being positioned for cutting. It is also possible to have different variations of log-positioner arms 24, such as the number and configuration. For example, there could be three log-positioner arms 24 that are rotated by the rotary drive shaft 30 that are able to transfer logs from the pick-up station 22 and to support the logs for cutting. Thus, the shaft-engaging member 26 can be any suitable shape that extends between the log-positioner arms 24, depending on the number of log-positioner arms used, while also providing a hole 28 or other type of engagement with the rotary drive shaft 30. Further, the log-positioner arms 24 could be any shape or cross-section, but are typically constructed so that the logs are able to roll along the intermediate surface 18 and/or to slide longitudinally along each of the log-transferring members 11 while supported on the supporting surface 16. For instance, the log-positioner arms 24 could be rectangular in cross section, but still enable the logs to roll on the intermediate surface 18 and to slide on the supporting surface 16, or the log-positioner arms could be plates that are conducive to rolling. Additionally, the lifting surface 14 could be a variety of shapes and configurations, as opposed to triangular as discussed above, provided the lifting surface is able to lift a log from the pick-up station 22 as the log-transferring members 11 are rotated.

Logs typically employ a loader and singulators to individually separate logs for processing, such as is shown in U.S. Pat. No. 6,543,498 to Woodham and U.S. Patent Application Publication No. 2003/0205444 to Woodham, which are both assigned to the assignee hereof and are incorporated herein by reference. With respect to the present invention, logs are loaded with a loader 29 and conveyed by one or more singulators 33, 34 to the pick-up station 22. FIG. 1 demonstrates that there can be a first singulator 33, having a plurality of lifter arms, which separates a single log from a loading station and rotates the log from the loading station to a second singulator 34. The second singulator 34 also includes a plurality of lifter arms, and as the second singulator continues to rotate, the log is transferred to the pick-up station 22. The first 33 and second 34 singulators are substantially retained within a sidewall such that only a portion of each singular is exposed while rotating. Therefore, as each of the first 33 and second 34 singulators rotate, the exposed portions of each of the singulators convey the log along the sidewall 37.

As the log is conveyed past the twelve o'clock position on the second singulator 34, the log descends by gravity along the sidewall 37 to the pick-up station 22. As shown in FIG. 4, the pick-up station 22 includes a row of hourglass rollers 31 that direct the log longitudinally to an even end 35 to position the log prior to being lifted by the log-transferring members 11. The rollers 31 ensure that each log is aligned at a predetermined constant position, i.e., the even end 35, prior to being lifted by the log-transferring members 11.

In order to minimize log waste, lasers 36, such as those shown in U.S. Pat. No. 6,543,498 to Woodham, are generally provided upstream of the log-transferring members 11 to generate a contour of the log to ensure that the log is properly positioned prior to cutting, although it is possible to provide a log-positioning system without incorporating lasers in alternative embodiments. The lasers 36 are capable of scanning the log either linearly or transversly to generate the contour. The lasers 36 could scan the log when supported by a singulator 33, 34, while the log is supported by the log-transferring member 11, or at any convenient location on the log-positioning system 10. The lasers 36 can detect not only the contour of the log, but also any defects that are to be avoided in later processing of the log into lumber. As shown in FIG. 1, the lasers 36 scan a respective log as the log is traveling to the pick-up station 22 and send a contour of the log to an information management system that actuates either a log pusher 38 or cutting blades 12, or both, to minimize log waste.

As illustrated in FIG. 4, the log-pusher 38 is located proximate to the even end 35 and is able to push the log longitudinally to a zero line while the log is supported on the supporting surface 16 of the log-transferring members 11. Thus, the log pusher 38 is actuated to push the log to any number of desired locations while the log is supported on the supporting surface 16 and a portion of the intermediate surface 18 depending on the log contour generated from the lasers 36. Logs are typically between about 10 and 16 feet, so the log pusher 38 would vary the distance pushed depending on the length and log contour to minimize log waste. The log-pusher 38 could also be positioned at other locations on the log-positioning system 10, such as in the pick-up station 22. Thus, the log-pusher 38 would position the log in the pick-up station 22 prior to be being picked up by the log-transferring members 11.

Three cutting blades 12 are arranged along a common shaft 40 and each cutting blade is attached to a saw arm 42. The saw arm 42 is actuated by a lifter arm 44 to lower and raise the cutting blades 12 into and out of engagement with the log. The cutting blades 12 typically engage the logs in a plane perpendicular to the centerline of the log.

The cutting blades 12 are continuously rotating, including while the cutting blades are not in engagement with the log. Thus, as the cutting blades 12 are lowered by the lifter arm 44, the cutting blades will immediately cut into the log when brought into engagement with the log and continue to rotate when raised out of engagement. Any number of cutting blades 12 may be actuated for a given log, as the amount of cuts made will depend on the log contour generated by the lasers 36, as well as the amount the log is moved by the log pusher 38.

In addition, each of the cutting blades 12 can slide along the common shaft 40 to various longitudinal positions. The cutting blades 12 can move to various positions to complement the distance the log pusher 38 pushes the log, as well as move in response to the log contour generated by the lasers 36. The cutting blades 12 slide to positions that will not engage the log-transferring members 11 when lowered to cut the log to prevent any damage to the cutting blades and/or log-transferring members.

After the cutting blades 12 cut the log, the log-transferring members 11 rotate to discharge the piece(s) of the log onto a conveyor 46. The conveyor 46 runs longitudinally and carries the log away from the log-positioning system 10 for further processing. For example, the cut logs can be carried to a debarker, and then further carried to a sawmill for processing into lumber.

The log-positioning system 10 can include various configurations to accommodate any number and size of logs and processing requirements. For example, although FIG. 1 shows two singulators 33, 34, it is understood that any number and type of singulators could be incorporated with the present invention to separate and convey a log to the pick-up station 22, and it is also possible to have no singulators. For instance, individual logs could be conveyed to the pick-up station 22 either transversly or longitudinally with a conveyor, rollers, or other device without the need for a singulator(s). In addition, although three cutting blades 12 are shown in FIG. 3, there may be any number and size of cutting blades 12 used that are operable to slide to various positions as described previously, as well as cut logs of any size. It is also understood that the cutting blades 12 could be stationary, i.e., not operable to slide, in alternative embodiments, while still enabling the log pusher 38 to move the log to various longitudinal positions based on the log contour generated by the lasers 36. Alternatively, it is possible to operate the log-positioning system 10 without incorporating a log pusher 38, while still using cutting blades 12 that can slide to various longitudinal positions depending on the log contour generated by the lasers 36. Additionally, in alternative embodiments, there could be no lasers 36, stationary cutting blades 12, or even no log-pusher 38, such that the log-positioning system 10 is manual. Thus, a log is conveyed to the pick-up station 22 and then transferred by the log-transferring members 11 without generating a log contour, or without providing any positional adjustment after being transferred to the pick-up station 22. Furthermore, different types of rollers 31 or even a conveyor, may be located in the pick-up station 22 of the present invention, that can carry the log to the even end 35 or log-pusher 38. There can also be several configurations for a support structure 48 to support the log-positioning system 10, such as the singulators 33, 34, log-transferring members 11, and cutting blades 12, in addition to any other structures used in various embodiments of the present invention.

The log-positioning system 10 of the present invention provides a fully automated system for separating, conveying, and cutting logs. The combination of the lasers 36, rollers 31, log-transferring members 11, log pusher 38, and cutting blades 12 provide an accurate system for minimizing log waste by positioning the log so that potential imperfections in the log are removed. Each of the log-transferring members 11 provides a surface that enables the log to slide when moved by the log pusher 38, and also conveys the log from the pick-up station 22 and supports the log while being cut by the cutting blades 12. Thus, the log-transferring members 11 can perform many different functions, which eliminates additional moving parts that would typically be required to perform multiple log-positioning procedures. Additionally, positioning the log while the log is supported on the log-transferring members 11 provides improved accuracy in positioning the logs, as the cutting blades 12 will immediately cut the logs when engaged with the log such that there is a lesser chance of the logs being misaligned when the logs are further transferred to a cutting station.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An apparatus for positioning a log for cutting comprising:
a plurality of log-transferring members having a common rotational axis and each having a plurality of log positioner arms extending generally about the rotational axis, the log positioner arms including a lifting surface and a supporting surface circumferentially spaced from the lifting surface, the lifting and supporting surfaces defining a cradle therebetween; and
a drive shaft operable to rotate the plurality of log-transferring members such that a log is retained within the cradle during rotation of the log from a first position adjacent to the lifting surface to a stationary position adjacent to the supporting surface, whereby the log is operable to be cut while supported in the stationary position.

2. An apparatus for positioning a log for cutting according to claim 1, wherein each of the log-transferring members includes four log positioner arms arranged about the rotational axis such that each of the four log positioner arms is operable to lift a plurality of logs sequentially on a respective lifting surface and to support the log on a respective supporting surface as the drive shaft is rotated.

3. An apparatus for positioning a log for cutting according to claim 1, wherein the cradle includes an intermediate surface extending between the lifting and supporting surfaces of each of the log positioner arms, and wherein the log is substantially in contact with the intermediate surface while the log is rotated from the first position to the stationary position.

4. An apparatus for positioning a log for cutting according to claim 3, wherein the lifting surface of each of the log positioner arms is defined such that the lifting surface engages the log and as the drive shaft is rotated, the log is advanced along the intermediate surface to the supporting surface.

5. An apparatus for positioning a log for cutting according to claim 3, wherein the log is supported in the stationary position within the cradle adjacent to the supporting surface and intermediate surface during cutting, and wherein further rotation of the drive shaft discharges the log from the log positioner arm.

6. An apparatus for positioning a log for cutting according to claim 1, wherein each of the log positioner arms is cylindrical such that the log is operable to slide longitudinally while supported in the stationary position.

7. An apparatus for positioning a log for cutting according to claim 1, wherein the log-transferring members are arranged in sets of at least two, each set of log-transferring members being coaxially arranged such that each set of log-transferring members is operable to simultaneously lift the log to be cut.

8. An apparatus for positioning a log for cutting according to claim 1, wherein each of the log-transferring members is operable to rotate at least 360 degrees.

9. A log positioning assembly for positioning a log for cutting, comprising:
a plurality of 360-degree rotatable log-transferring members having a common rotational axis and each having a plurality of log positioner arms extending generally about the rotational axis, the log positioner arms including a lifting surface and a supporting surface circumferentially spaced from the lifting surface, the lifting and supporting surfaces defining a cradle therebetween; and
a log positioner operable to longitudinally move a log to a predetermined position while the log is supported on the supporting surface.

10. A log positioning assembly according to claim 9, wherein each of the log-transferring members includes four log positioner arms arranged about the rotational axis such that each of the four log positioner arms is operable to lift a plurality of logs sequentially on a respective lifting surface and supporting the log on a respective supporting surface as the drive shaft is rotated.

11. A log positioning assembly according to claim 10, wherein the log positioner is operable to move each log while the log is supported on a respective supporting surface on each of the four log positioner arms.

12. A log positioning assembly according to claim 9, further comprising a plurality of rollers located in a pick-up station upstream of each of the log-transferring members, the rollers rotating such that a log is advanced to a predetermined longitudinal position.

13. A log positioning assembly according to claim 9, further comprising a scanner operable to scan a log contour and generate a preferred cutting solution.

14. A log positioning assembly according to claim 13, wherein the log positioner moves the log to a predetermined longitudinal position based on the log contour.

15. A log positioning assembly according to claim 13, further comprising a plurality of cutting blades operable to cut the log while the log is supported on the supporting surface of each of the log positioner arms, wherein at least one of the plurality of cutting blades is operable to longitudinally slide relative to the log-transferring members to a predetermined position based on the log contour.

16. A method of positioning a log for cutting, the method comprising:
providing a plurality of log-transferring members having a common rotational axis and each having a plurality of log positioner arms extending generally about the rotational axis, the log positioner arms including a lifting surface and a supporting surface, the lifting and supporting surfaces defining a cradle therebetween;
rotating the plurality of log-transferring members about a drive shaft such that a log is lifted and retained within the cradle during rotation from a first position adjacent to the lifting surface to a second position adjacent to the supporting surface;
stopping the rotation of the log-transferring members at a predetermined position; and
cutting the log in at least one location with at least one of a plurality of cutting blades while the log is supported on the supporting surface.

17. A method of positioning a log for cutting according to claim 16, further comprising directing the log longitudinally to a predetermined position with a plurality of rollers prior to rotating the plurality of log-transferring members about the drive shaft.

18. A method of positioning a log for cutting according to claim 17, further comprising moving the log longitudinally to a predetermined position prior to cutting the log, wherein the log is moved in a direction opposite to the direction of the directing step.

19. A method of positioning a log for cutting according to claim 16, further comprising scanning the log to generate a log profile.

20. A method of positioning a log for cutting according to claim 19, further comprising moving the log to a predetermined longitudinal position based on the log profile.

21. A method of positioning a log for cutting according to claim 19, further comprising sliding at least one of the plurality of cutting blades longitudinally to a predetermined position based on the log profile prior to cutting the log.

22. A method of positioning a log for cutting according to claim 16, further comprising discharging the log from the log positioner arms following the cutting step, wherein discharging includes further rotating the log-transferring members.

23. A system for positioning logs for cutting, comprising:
a pick-up station into which a log is deposited for transfer to a cutting station;
a first log positioner operable to longitudinally move a log to a predetermined position while in the pick-up station;
a single-stage feeder operable to lift the log from the pick-up station and advance the log from the pick-up station to the cutting station at which the log is cut by at least one saw;
the single-stage feeder comprising a plurality of rotary log-transferring members mounted on and longitudinally spaced apart along a rotary drive shaft, each log-transferring member defining a log-lifting surface and a log-supporting cradle circumferentially spaced from the log-lifting surface in the rotational direction of the log-transferring member, the log-transferring members being structured and arranged such that a log in the pick-up station is engaged by the lifting surfaces of the log-transferring members as the log-transferring members are rotated into a pick-up position by the drive shaft, the drive shaft then further rotating the log-transferring members into a cutting position so as to lift and move the log from the pick-up station into the log-supporting cradles of the log-transferring members;
at least one saw positioned adjacent the single-stage feeder and structured and arranged to be advanced to saw through a log held in the cutting position in the log-supporting cradles; and
a second log positioner operable to longitudinally move a log in the cutting station to a predetermined position.

24. A system for positioning logs for cutting according to claim 23, wherein the first log positioner comprises a plurality of rollers.

25. A system for positioning logs for cutting according to claim 23, wherein each of the log-transferring members is operable to rotate at least 360 degrees.

26. A system for positioning logs for cutting according to claim 23, further comprising a driven saw positioning system operable to adjust the longitudinal positioning of each saw with respect to the log-transferring members.

27. A system for positioning logs for cutting according to claim 26, wherein the driven saw positioning system comprises a scanner operable to scan a log contour and generate a preferred cutting solution.

28. A system for positioning logs for cutting according to claim 27, wherein the second log positioner moves the log to a predetermined longitudinal position based on the log contour.

29. A system for positioning logs for cutting, comprising:
a first log positioner operable to longitudinally move a log to a predetermined position while the log is in a pick-up station, the log being deposited into the pick-up station for transfer to a cutting station;
a single-stage feeder operable to lift the log from the pick-up station and advance the log from the pick-up station to the cutting station at which the log is cut by at least one saw;
the single-stage feeder comprises a plurality of 360-degree rotary log-transferring members longitudinally spaced apart along a rotatary drive shaft, each log-transferring member defining a log-lifting surface and a log-supporting cradle circumferentially spaced from the log-lifting surface in the rotational direction of the log-transferring member, the log-transferring members being structured and arranged such that a log in the pick-up station is engaged by the lifting surfaces of the log-transferring members as the log-transferring members are rotated into a pick-up position by the drive shaft, the drive shaft then further rotating the log-transferring members into a cutting position so as to lift and move the log from the pick-up station into the log-supporting cradles of the log-transferring members; and
at least one saw positioned adjacent the single-stage feeder and structured and arranged to be advanced to saw through a log held in the cutting position in the log-supporting cradles.

30. A system for positioning logs for cutting according to claim 29, wherein the first log positioner comprises a plurality of rollers.

31. A system for positioning logs for cutting according to claim 29, further comprising a driven saw positioning system operable to adjust the longitudinal positioning of each saw with respect to the log-transferring members.

32. A system for positioning logs for cutting according to claim 29, wherein the driving saw positioning system comprises a scanner operable to scan a log contour and generate a preferred cutting solution.

33. A system for positioning logs for cutting according to claim 32, wherein the first log positioner moves the log to a predetermined longitudinal position based on the log contour.

34. A system for positioning logs for cutting according to claim 29, further comprising a second log positioner operable to longitudinally move a log in the cutting station to a predetermined position.

35. An assembly for positioning logs for cutting, comprising:
at least one saw positioned adjacent to a single-stage feeder, the single-stage feeder comprising a plurality of log-transferring members, wherein the saw is structured and arranged to be advanced to saw through a log held by the plurality of log-transferring members;
a log positioner operable to longitudinally move a log held by each of the log-transferring members to a predetermined position; and
a driven saw positioning system operable to adjust the longitudinal positioning of each saw with respect to the single stage feeder.

36. An assembly for positioning logs for cutting according to claim 35, wherein the driven saw positioning system comprises a scanner operable to scan a log contour and generate a preferred cutting solution.

37. A system for positioning logs for cutting according to claim 36, wherein the second log positioner moves the log to a predetermined longitudinal position based on the log contour.

38. An assembly for positioning logs for cutting according to claim 35, wherein each log-transferring member defines a lifting surface and a supporting surface circumferentially spaced from the lifting surface, the lifting and supporting surfaces defining a cradle therebetween.

39. An assembly for positioning logs for cutting according to claim 38, further comprising at least one saw positioned adjacent each of the log-transferring members and structured and arranged to be advanced to saw through a log held on a respective supporting surface within the log-supporting cradle.
